(19) United States
(12) Patent Application Publication
(10) Pub. No.: US 2016/0124205 A1
(43) Pub. Date: May 5, 2016

(54) Simple, Fast and Plasma-Free Method of Fabricating PDMS Microstructures on Glass by Pop Slide Pattering

(71) Applicant: YALE UNIVERSITY, New Haven, CT (US)

(72) Inventors: Ramesh Ramji, New Haven, CT (US); Kathryn Miller-Jensen, New Haven, CT (US); Nafeesa T. Khan, New Haven, CT (US)

(21) Appl. No.: 14/924,037

(22) Filed: Oct. 27, 2015

Related U.S. Application Data
(60) Provisional application No. 62/069,035, filed on Oct. 27, 2014.

(51) Int. Cl. G02B 21/34; B29C 41/20; B29C 41/04

(52) U.S. Cl. CPC G02B 21/34; B29C 41/045; B29C 41/20; B29K 2083/00

(57) ABSTRACT

The present invention relates to patterned microstructures on substrates and methods of making the same. The method completely eliminates the need for elements such as transfer membranes, UV lamps, plasma cleaners, reactive ion etchers, and mask aligners.

### CROSS-REFERENCE TO RELATED APPLICATIONS

This application claims priority to U.S. Provisional Patent Application No. 62/069,035, filed Oct. 27, 2014, the contents of which are incorporated by reference herein in its entirety.

### STATEMENT REGARDING FEDERALLY SPONSORED RESEARCH OR DEVELOPMENT

This invention was made with government support under grant number U01-CA164252 awarded by the National Institutes of Health. The government has certain rights in the invention.

### BACKGROUND OF THE INVENTION

Glass is widely used as a standard substrate for microfluidic and microchip based applications, especially in biological studies in the form of microscope slides, coverslips, and petri dishes (Xu Yet al., Lab Chip, 2013, 13:1048-1052). It is cheap, easily available, inert to many chemicals, and stable over an extended range of temperature. The transparent nature of glass facilitates imaging of cells and other biological samples. These properties make it ideal for biological imaging and other bioanalytical applications. Patterning microstructures on the surface of glass is advantageous for bioanalytical assays and also permits the confinement and study of the interaction of cells in individual microchambers.

Several recent studies have described different ways of patterning microstructures on glass. Simple methods of patterning photo-definable PDMS on glass using UV light have been reported, which use either free radical initiators or cinnamated PDMS to assist in photo-polymerizing their siloxane polymers (Bhagat AAS et al., Lab Chip, 2007, 7:1192-1197; Chen J et al., J Polym Sci Al, 2008, 46:3482-3487). Hsu et al. reported a PDMS membrane transferring technique to pattern PDMS microcanals on glass with a minimum resolution of 50 μm (Hsu CH et al., Lab Chip, 2004, 4:420-424). Chen et al. reported a precise PDMS surface micromachining method using reactive ion etching to produce hollow PDMS films (Chen W et al., Lab Chip, 2012, 12:391-395), while Hwang et al. described a bench top method of fabricating poly-ethylene glycol diacrylate (PEGDA) microstructures on glass by standard photolithography (Hwang CM et al., Biofabrication, 2010, 2:045001). Nevertheless, these methods either have complex fabrication steps, require a clean room facility with expensive reactive ion etchers, or suffer from poor transfer efficiency for small feature sizes (<50 μm) as in the case of membrane transfer method.

There is a need in the art for simpler, improved methods for patterning microstructures on substrates. The present invention meets this need.

### SUMMARY OF THE INVENTION

The present invention relates to patterned microstructures on substrates and methods of making the same. The method completely eliminates the need for elements such as transfer membranes, UV lamps, plasma cleaners, reactive ion etchers, and mask aligners.

In one aspect, the invention relates to a method of fabricating devices having microstructures. The method comprises the steps of: placing a preformed mold on a heat source; covering the preformed mold with a polymer solution; placing a substrate on the preformed mold and polymer solution; heating the heat source to at least one temperature between 50 and 100° C. and holding for at least one period of time between 1 and 10 minutes; heating the heat source to at least one temperature between 100 and 150° C. and holding for at least one period of time between 1 and 5 minutes; and removing the substrate from the preformed mold; wherein the substrate is removed with microstructures intact, having a thin polymer layer between the substrate and the microstructures. In one embodiment, the method further comprises a step of removing air pockets from the polymer solution by degassing after placing a substrate on the preformed mold and polymer solution. In one embodiment, the method of claim 1, further comprising a step of removing heat and trimming excess polymer from the substrate after heating the heat source to at least one temperature between 50 and 100° C. and holding for at least one period of time between 1 and 10 minutes.

In another aspect, the invention relates to a method of fabricating glass slides having PDMS microstructures. The method comprises the steps of: placing a preformed mold on a heat source; covering the preformed mold with a PDMS solution; placing a glass slide on the preformed mold and PDMS solution; removing air pockets from the PDMS solution by degassing; heating the heat source to about 60° C. for 10 minutes, 65° C. for 5 minutes, 70° C. for 5 minutes, 80° C. for 10 minutes, 90° C. for 3 minutes, and 100° C. for 1 minute; removing heat and trimming excess PDMS from the glass slide; heating the heat source to about 145° C. for 1-2 minutes; and removing the glass slide from the preformed mold; wherein the glass slide is removed with microstructures intact, having a thin PDMS layer between the glass slide and the microstructures.

In another aspect, the invention relates to a high throughput method of fabricating devices having microstructures. The method comprises the steps of: placing a substrate on a heat source; covering the substrate surface with a polymer solution; heating the heat source to at least one temperature between 50 and 75° C. and holding for at least one period of time between 1 and 5 minutes; placing a preformed mold on the substrate and polymer solution; heating the heat source to at least one temperature between 75 and 150° C. and holding for at least one period of time between 1 and 5 minutes; and removing the preformed mold from the substrate; wherein the substrate retains intact microstructures, having a thin polymer layer between the substrate and the microstructures.

In another aspect, the invention relates to a high throughput method of fabricating glass slides having PDMS microstructures. The method comprises the steps of: placing a glass slide on a heat source; covering the glass slide surface with a PDMS solution; heating the heat source to about 60° C., 65° C., and 70° C. for 1.5 minutes at each temperature; placing a preformed mold on the glass slide and PDMS solution; heating the heat source to about 80° C., 90° C., 100° C., and 145° C. for 1 minute at each temperature; and removing the preformed mold from the glass slide; wherein the glass slide retains intact microstructures, having a thin PDMS layer between the glass slide and the microstructures.

In one embodiment, the polymer solution comprises a thermosetting polymer and an organic solvent. In one embodiment, the PDMS solution comprises a 1:1 mixture of hexane and PDMS mixture. In one embodiment the PDMS mixture comprises a 1:10 mixture of curing agent and PDMS base. In one embodiment, the preformed mold comprises a photoresist. In one embodiment, the preformed mold comprises SU-8. In one embodiment, the preformed mold is resistant to organic solvents. In one embodiment, the preformed material is resistant to temperatures of at least 200° C.

In one embodiment, the substrate comprises a planar surface. In one embodiment, the substrate comprises a glass slide. In one embodiment, the substrate is resistant to temperatures of at least 200° C.

In one embodiment, a weight is placed on the substrate or mold to decrease the thickness of the thin polymer or PDMS layer. In one embodiment, the intact microstructures are selected from the group consisting of: micropillars, microwells, microchannels, and microlenses. In one embodiment, the methods of the present invention further comprise a step of covering at least a portion of the intact microstructures with a second substrate surface.

In another aspect, the invention relates the devices fabricated by the methods of the present invention.

### BRIEF DESCRIPTION OF THE DRAWINGS

The following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities of the embodiments shown in the drawings.

FIG. 1 depicts an exemplary device of the present invention having microstructures fabricated by the pop slide patterning technique.

FIG. 2A through FIG. 2C depict SEM images of PDMS microstructures patterned on a glass slide. (FIG. 2A) Pillars with sides 5.5 μm and 11 μm in height resulting in an aspect ratio of 2. (FIG. 2B) Rectangular wells of widths ranging from 10 μm to 200 μm. (FIG. 2C) PDMS microcanals with serpentine features to help in mixing of fluids are easily micropatterned on the surface of glass.

FIG. 3A through FIG. 3D depict SEM images of circular PDMS structures patterned on a glass slide using pop slide patterning technique. (FIG. 3A and FIG. 3B) Circular wells of low and high aspect ratio on a glass slide. (FIG. 3C and FIG. 3D) Circular pillar on low and high aspect ratio on a glass slide.

FIG. 4A through FIG. 4D depict SEM images of triangular PDMS structures patterned on a glass slide using pop slide patterning technique. (FIG. 4A) Triangular wells of aspect ratio 0.33, 0.25, and 0.06 from left to right. (FIG. 4B) Triangular wells of aspect ratio 0.66, 0.5, and 0.133 from left to right. (FIG. 4C) Triangular pillars of aspect ratio 0.33, 0.25, and 0.1 from left to right. (FIG. 4D) Triangular pillars of aspect ratio 1.27, 0.95, and 0.38 from left to right. Scale bars represent 50 μm.

FIG. 5A through FIG. 5D depict SEM images of square PDMS structures patterned on a glass slide using pop slide patterning technique. (FIG. 5A) Square wells of aspect ratios 0.33, 0.2, and 0.06 from left to right. (FIG. 5B) Square wells of aspect ratio 0.66, 0.4, and 0.13 from left to right. (FIG. 5C) Square pillars of aspect ratio 0.5, 0.25, and 0.1 from left to right. (FIG. 5D) Square pillars of aspect ratio 1.9, 0.95, and 0.38 from left to right. Scale bars represent 50 μm.

FIG. 6 is a flowchart depicting an exemplary method of fabricating devices having microstructures using the pop slide patterning technique.

FIG. 7 is a flowchart depicting an exemplary method of fabricating devices having microstructures using PDMS and glass slides.

FIG. 8 is a schematic depicting the pop slide patterning technique of the present invention.

FIG. 9 is a flowchart depicting an exemplary high throughput method of fabricating devices having microstructures using the pop slide patterning technique.

FIG. 10 is a flowchart depicting an exemplary high throughput method of fabricating devices having microstructures using PDMS and glass slides.

FIG. 11A and FIG. 11B depict the results of experiments testing the effect of various parameters on PDMS structure properties. (FIG. 11A) Spin speed profile of varying thickness of the PDMS: hexane mixture (1:1). (FIG. 11B) Plot representing the pop slide patterning efficiency indicating uniform pattern heights for 3 experimental replicates.

FIG. 12 is a table listing temperatures and corresponding time required to bake a silicon master mold in the pop slide patterning technique.

FIG. 13A through FIG. 13D depict SEM images illustrating the effect of adding weights to the PDMS microwells patterned on a glass slide. FIG. 13A and FIG. 13B represent features produced without weights during the pop slide patterning technique. The results show a 28-30 μm thick PDMS layer between the glass slide and the pattern features. FIG. 13C and FIG. 13D represent features produced by the same approach while adding a 37 g weight block on top of the glass slide. This reduces the thickness of the lower PDMS layer to 7-8 μm. Scale bars in FIG. 13A and FIG. 13B represent 100 μm. Scale bars in FIG. 13C and FIG. 13D represent 25 μm.

FIG. 14A through FIG. 14D depict the results of experiments investigating various applications of the PDMS microwells. (FIG. 14A) Fluorescent images of protein (FITC-B SA) spotted inside microwell array patterned on a glass slide. (FIG. 14B) Schematic representation of a cell-based assay with capture antibodies spotted/coated on the microwell array. (FIG. 14C) Fluorescent image indicating live cell stain (Calcein AM) on cells attached inside microwell array patterned on a glass slide. Scale bars in FIG. 14A and FIG. 14C represent 50 μm. (FIG. 14D) Schematic representation of a cell based assay with cells attached on the microwell array while sandwiched under a capture antibody coated slide.

FIG. 15 depicts a glass slide with microstructures patterned using an exemplary high throughput method of the present invention. The magnified view depicts the 7 μm U-shaped trenches casted from a 7 μm U-shaped pillared microarray.

### DETAILED DESCRIPTION

The present invention relates to patterned microstructures on substrates and method of making the same. In certain embodiments, the patterned microstructures comprise polydimethylsiloxane (PDMS) fabricated from a unique combination of PDMS and a releasing agent. The use of releasing agent eases the separation of the rigid glass slide from a master mold. The method completely eliminates the need for elements such as transfer membranes, UV lamps, plasma cleaners, reactive ion etchers, and mask aligners. In certain embodiments, the PDMS microstructures are made using SU-8 master molds produced from low resolution plastic photomasks (having a minimum feature size of about 10 μm) as well as high resolution chrome photomasks (having a minimum feature size of about 5 μm) and the results were easily reproduced.

### Definitions

It is to be understood that the figures and descriptions of the present invention have been simplified to illustrate elements that are relevant for a clear understanding of the present invention, while eliminating, for the purpose of clarity, many other elements typically found in the art. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined elsewhere, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

The term “curing agent” as used herein describes a compound or mixture of compounds that is added to a polymeric composition to promote or control the curing reaction. In certain systems, the term “curing agent” may also describe chain extenders, curatives or cross-linkers.

As used herein the term microstructure, nanostructure, as well as any idiomatic variation thereof such as micropillar, microwell, microchannel, nanopillar, nanowell, nanochannel, and the like, is intended to contemplate substrate features much smaller than that of the substrate dimensions, typically less than one millimeter laterally and vertically.

As used herein, a thermoset or a thermosetting material refers to a solid material that solidifies or sets irreversibly when heated. The solid material is also referred to as a precursor of a thermoset polymer. This irreversible property is usually associated with a cross-linking reaction of the molecular constituents induced by heat.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments there between. This applies regardless of the breadth of the range.

### Devices Having Microstructures

The invention provides devices having a plurality of microstructures on a substrate. The microstructures are adaptable to a wide range of dimensions and configurations.

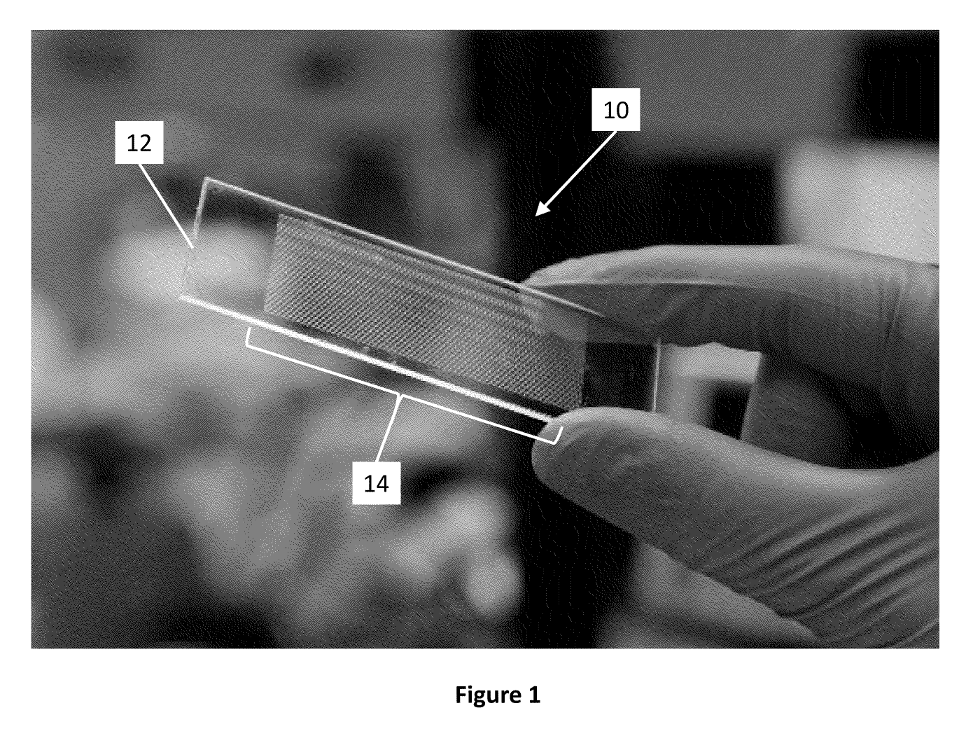

Referring now to FIG. 1, an exemplary device 10 is depicted. Device 10 comprises substrate 12 and microstructures 14. Substrate 12 can be any suitable substrate. For example, substrate 12 can be any substantially planar surface of any desired material. Substrate 12 preferably comprises a material that can withstand high temperatures, such a material having a melting point that is at least 200° C. In one embodiment, substrate 12 is glass, such as a glass microscope slide. In another embodiment, substrate 12 is a flat polymer surface. Microstructures 14 can comprise any suitable material. In one embodiment, microstructures 14 comprise a material that is a thermosetting material, such as polytetrafluoroethylene (PTFE), poly-urethane, and other fluorinated polymers. In one embodiment, microstructures 14 comprises PDMS.

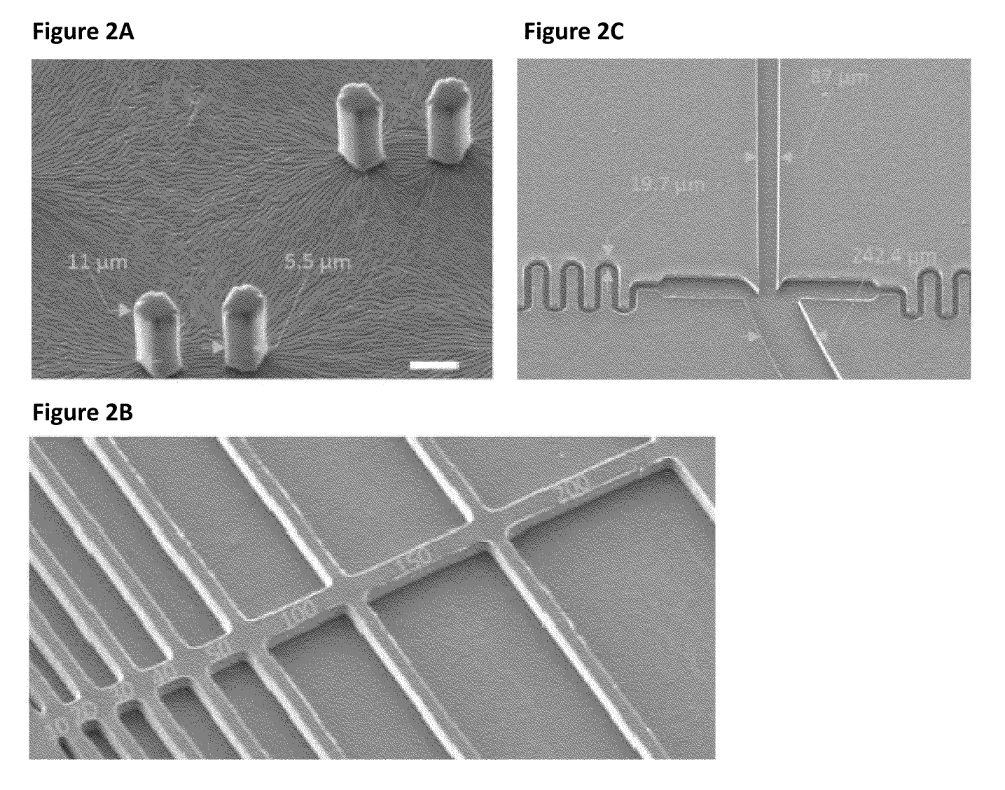

Microstructures 14 can take on a variety of shapes and sizes in the micron range. For example, microstructures 14 can have dimensions between 1 μm and 1000 μm. Microstructures 14 can also have dimensions that are accurate to the nanometer. Microstructures 14 can form raised structures that are freestanding on a substrate surface. Microstructures 14 can also form indented structures defined by surrounding material having a higher height. Referring now to FIG. 2A through FIG. 2C, shape and size ranges are illustrated by exemplary microstructures. FIG. 2A depicts an SEM image of micropillars having widths of 5.5 μm and heights of 11 μm. FIG. 2B depicts an SEM image of microwells having widths between 10 μm and 200 μm. FIG. 2C depicts an SEM image of microchannels having varying geometry with widths between 19.7 μm and 242.4 μm.

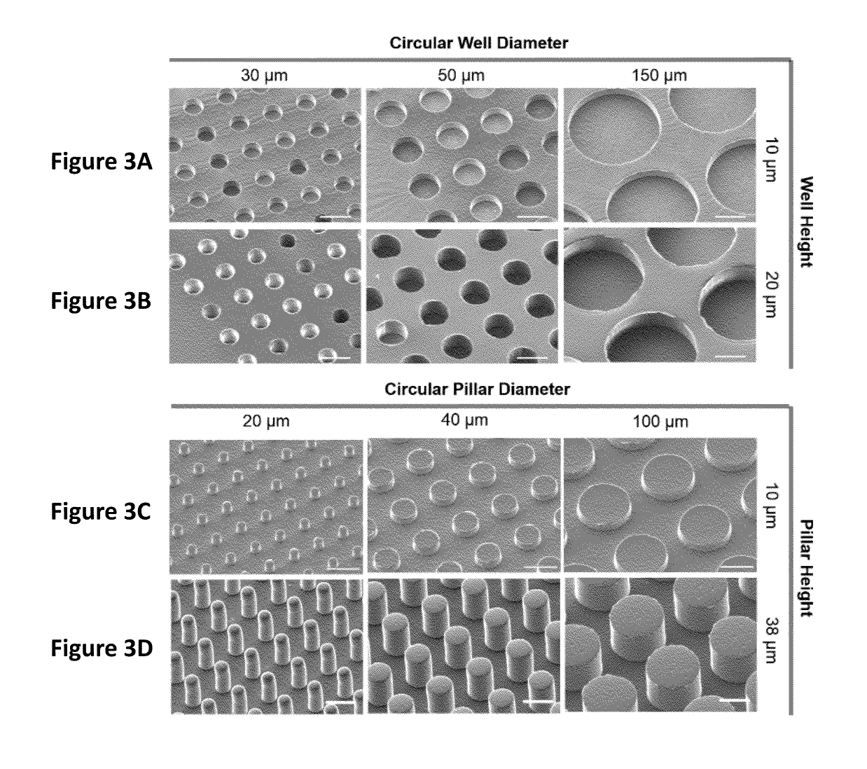

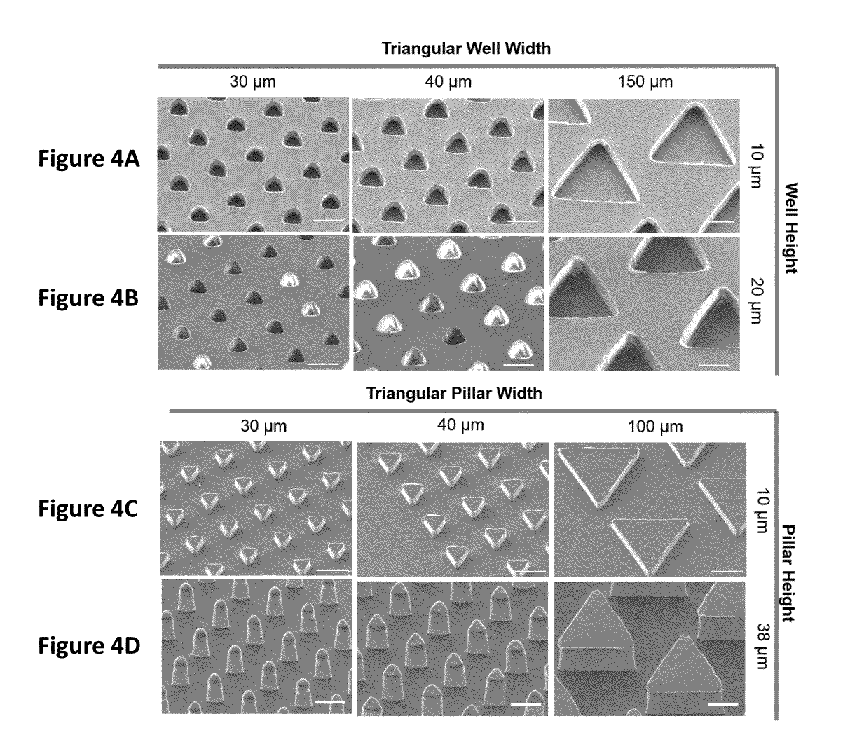

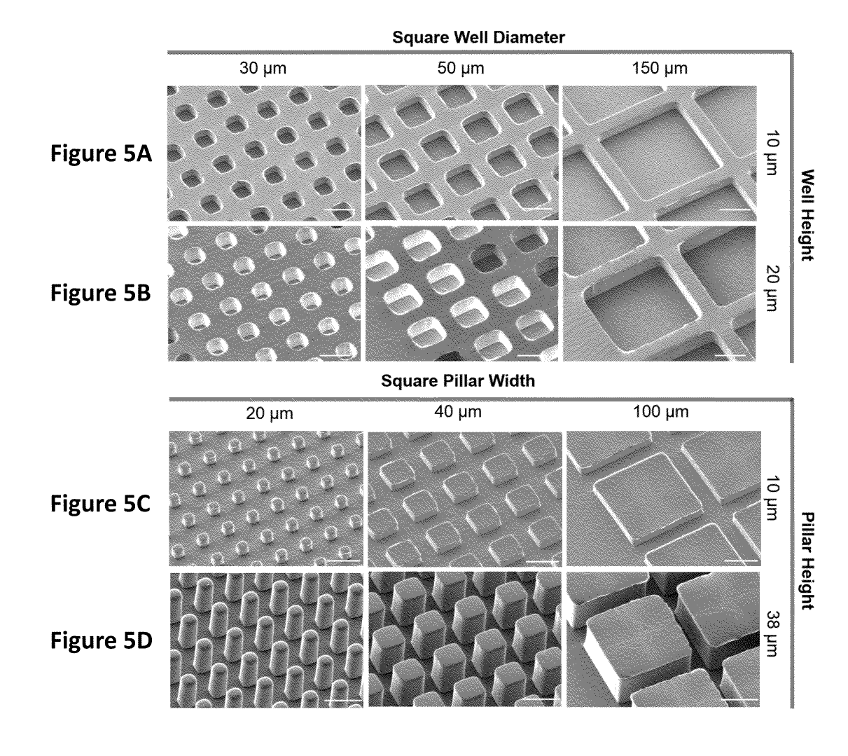

There is no limitation to the particular geometry of the microstructures of the present invention. For example, non-limiting geometries include circles, ovals, polygons, linear channels, non-linear channels, gradations, and the like. FIG. 3A through FIG. 3D, FIG. 4A through FIG. 4D, and FIG. 5A through FIG. 5D illustrate the versatility in size and shape of the microstructures. Referring now to FIG. 3A through FIG. 3D, various embodiments of microstructures having circular shapes are depicted. FIG. 3A and FIG. 3B depict microwells with circular cross-sections having diameters between 30 μm and 150 μm and depths between 10 μm and 20 μm. FIG. 3C and FIG. 3D depict micropillars with circular cross-sections having diameters between 20 μm and 100 μm and heights between 10 μm and 38 μm.

Referring now to FIG. 4A through FIG. 4D, various embodiments of microstructures having triangular shapes are depicted. FIG. 4A and FIG. 4B depict microwells with triangular cross-sections having widths between 30 μm and 150 μm and depths between 10 μm and 20 μm. FIG. 4C and FIG. 4D depict micropillars with triangular cross-sections having widths between 30 μm and 100 μm and heights between 10 μm and 38 μm.

Referring now to FIG. 5A through 5D, various embodiments of microstructures having quadrilateral shapes are depicted. FIG. 5A and FIG. 5B depict microwells with square cross-sections having widths between 30 μm and 150 μm and depths between 10 μm and 20 μm. FIG. 5C and FIG. 5D depict micropillars with square cross-sections having widths between 20 μm and 100 μm and heights between 10 μm and 38 μm.

The devices of the present invention are amenable to any suitable use. For example, devices comprising microwells can be used in applications such as individual cell culture and high throughput screening assays. Devices comprising microchannels can be used in applications such as microfluidic studies and lab-on-a-chip devices. Devices comprising micropillars can be used in applications such as microfilters and sorting devices. In certain embodiments, the devices can comprise a graded microstructure surface. Devices having a graded microstructure surface are amenable for optical applications, such as micro lenses.

### Pop Slide Patterning Fabrication

The invention provides methods of making the devices described elsewhere herein. The methods, termed “pop slide patterning”, completely eliminate the need for elements such as transfer membranes, UV lamps, plasma cleaners, reactive ion etchers, and mask aligners. The methods also relate to small scale and high throughput fabrication schemes for making the devices.

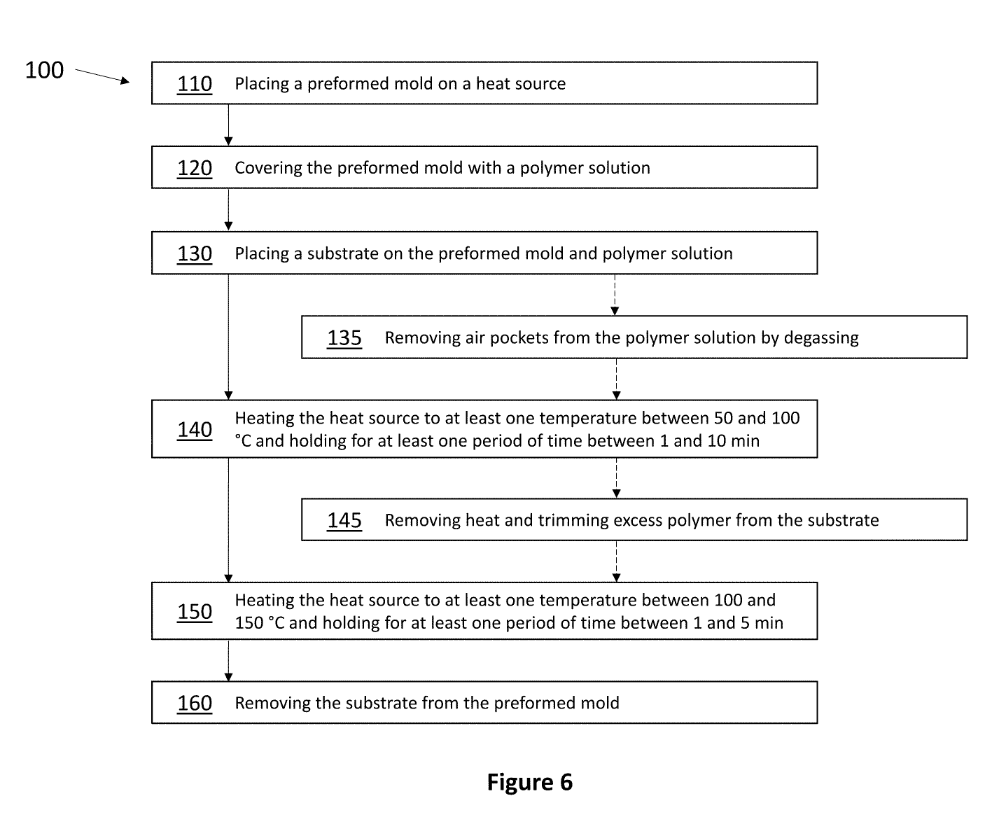

Referring now to FIG. 6, an exemplary small scale method 100 is presented. Method 100 begins with step 110, wherein a preformed mold is placed on a heat source. The heat source can be any suitable heat source, such as a hot plate or a furnace. In step 120, the preformed mold is covered with a polymer solution. The polymer solution may be simply poured on the preformed mold, or it may be subjected to additional steps to ensure even coating, such as by spin coating. In step 130, a substrate is placed on the preformed mold and polymer solution, such that the polymer solution is between the substrate and the preformed mold. Optionally, in step 135, air pockets are removed from the polymer solution via degassing, such as by sonication, centrifugation, or vacuum treatment. In step 140, the heat source is heated to at least one temperature between 50 and 100° C. and held for at least one period of time between 1 and 10 minutes. Optionally, in step 145, the heat may be removed to trim excess polymer from the substrate. In step 150, the heat source is heated to at least one temperature between 100 and 150° C. and held for at least one period of time between 1 and 5 minutes. In step 160, the substrate is removed from the mold.

The preformed mold can comprise any suitable material. Preferably, the preformed mold comprises a material that can withstand high temperatures, such as a material having a melting point that is at least 200° C. Preferably, the preformed mold comprises a material that is resistant to organic solvents, such as hexane and isopropyl alcohol. In one embodiment, the preformed mold is made from a photoresist. In one embodiment, the preformed mold is made from SU-8. In another embodiment, the preformed mold comprises etched silicon.

The preformed mold is prepared in advance of the present methods. The preformed mold comprises features that are the inverse of the desired micropattern features in a device of the present invention. For example, if the desired micropattern features comprise micropillars, the preformed mold should comprise microwells having the same dimensions as the desired micropillars. The preformed mold can be made using any suitable technique common to the art, such as photolithography, etching, and the like.

The polymer solution comprises a fluid polymer mixture and an organic solvent. The fluid polymer mixture can comprise any suitable polymer in solution. In one embodiment, the polymer in solution is a thermosetting polymer. In one embodiment, the polymer in solution is PDMS in curing agent. The organic solvent can be any suitable organic solvent, such as hexane and isopropyl alcohol. Preferably, the organic solvent has a low boiling point, such as a boiling point below 150° C. Preferably, the organic solvent is soluble in the fluid polymer mixture.

The substrate, as described elsewhere herein, can be any suitable substrate. For example, the substrate can be any substantially planar surface of any desired material. The substrate preferably comprises a material that can withstand high temperatures, such a material having a melting point that is at least 200° C. In one embodiment, the substrate is glass, such as a glass microscope slide. In another embodiment, the substrate is a flat polymer surface.

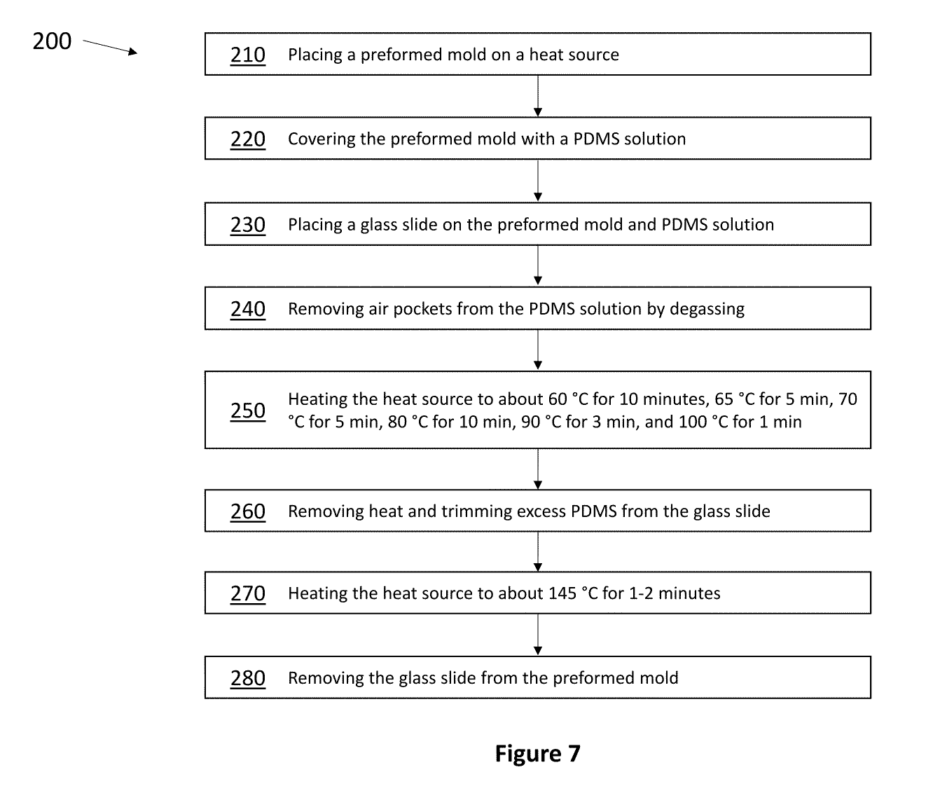

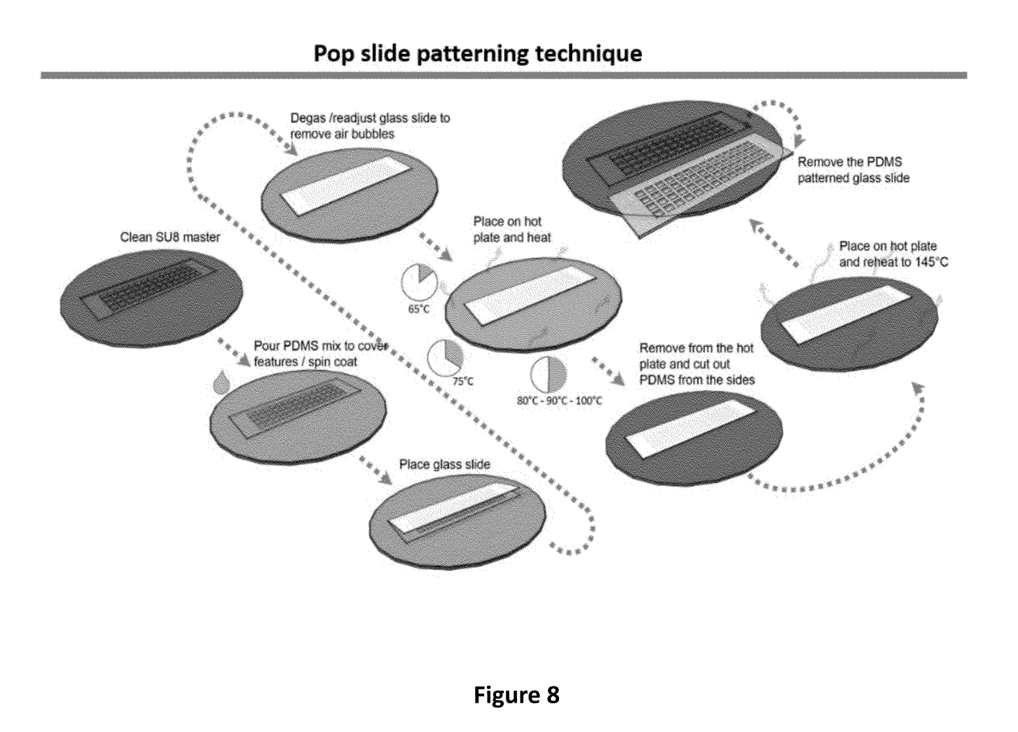

Referring now to FIG. 7 and FIG. 8, method 100 has been adapted to method 200 for fabricating PDMS microstructures on standard glass microscope slides. Method 200 begins with step 210, wherein a preformed mold is placed on a heat source. In step 220, the preformed mold is covered with a PDMS solution, the solution comprising a 1:1 ratio of hexane and PDMS (1:10 PDMS base and curing agent). In Step 230, a glass slide is placed on the preformed mold and PDMS solution, such that the PDMS solution is between the preformed mold and the glass slide. In step 240, the PDMS solution is subjected to a degassing step to remove air pockets. In step 250, the heat source is heated to about 60° C. for 10 minutes, about 65° C. for 5 minutes, about 70° C. for 5 minutes, about 80° C. for 10 minutes, about 90° C. for 3 minutes, and about 100° C. for 1 minute. In step 260, the heat is removed and excess PDMS is trimmed from the glass slide. In step 270, the heat source is heated to about 145° C. for 1-2 minutes, wherein the expanding hexane causes the glass slide to pop out from the preformed mold. In step 280, the glass slide containing microstructures is removed from the preformed mold.

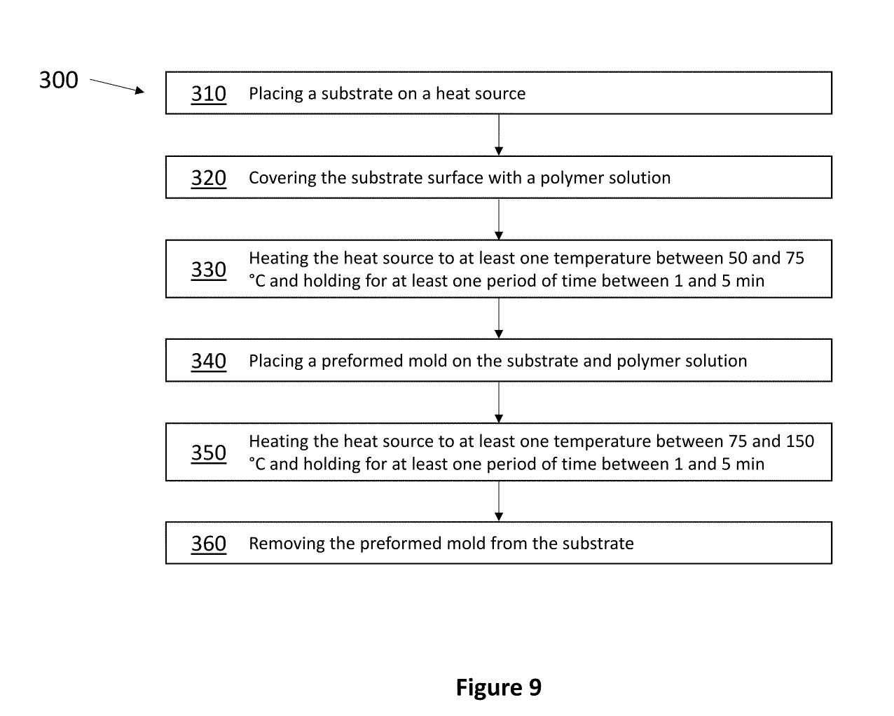

Referring now to FIG. 9, an exemplary high throughput method 300 is presented. Method 300 is suitable for automated processes, wherein a large number of devices having microstructures can be produced simultaneously. Method 300 begins with step 310, wherein a substrate is placed on a heat source. In step 320, the substrate surface is covered with a polymer solution. In step 330, the heat source is heated to at least one temperature between 50 and 75° C. and held for at least one period of time between 1 and 5 minutes. In step 340, a preformed mold is placed on the polymer solution and the substrate, such that the polymer solution is between the preformed mold and the substrate. In step 350, the heat source is heated to at least one temperature between 75 and 150° C. and held for at least one period of time between 1 and 5 minutes. In step 360, the preformed mold is removed from the substrate.

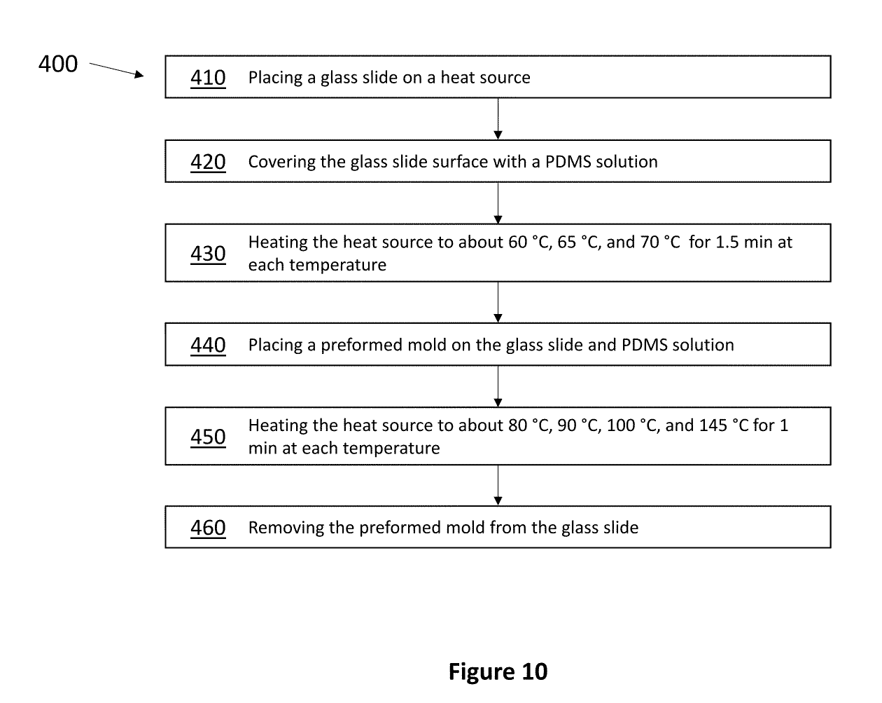

Referring now to FIG. 10, method 300 has been adapted to method 400 for fabricating PDMS microstructures on standard glass microscope slides. Method 400 begins with step 410, wherein a glass slide is placed on a heat source. In step 420, the glass slide is covered with a PDMS solution (described elsewhere herein). In step 430, the heat source is heated to about 60° C. for 1.5 minutes, about 65° C. for 1.5 minutes, and about 70° C. for 1.5 minutes. In step 440, a preformed mold is placed on the glass slide and PDMS solution, such that the PDMS solution is between the preformed mold and the glass slide. In step 450, the heat source is heated to about 80° C. for 1 minute, about 90° C. for 1 minute, about 100° C. for 1 minute, and about 145° C. for 1 minute. In step 460, the preformed mold is removed from the glass slide.

The methods of the present invention are amenable to modification for further improvements or to modify the parameters of the fabricated device. For example, the temperature holding times may be increased to allow for additional polymer curing time, which may be advantageous for particular microstructures, such as deep microwells or tall micropillars. The thickness of the layer of polymer between the substrate and the microstructures can be adjusted by adding weight to the substrate in methods 100 and 200 or by adding weight to the preformed mold in methods 300 and 400, wherein additional weight decreases the thickness of the polymer layer.

Fabricated devices intended for use in microfluidics or lab-on-a-chip applications, the methods may encompass additional steps to incorporate features relevant to channel formation and fluid flow. For example, the methods may further comprise a step of providing a second substrate and placing the second substrate over at least a portion of the microstructures of the fabricated device such that the second substrate surface forms a watertight seal over any microchannels and reservoirs. The methods may also further comprise steps of modifying the fabricated microchannels and reservoirs, by etching or any other means, to alter the flowpath or connectivity of the microchannels to fit the intended use of the device. The fabricated microwell patterned slides can also be sandwiched with other plain glass slides to form individual reaction chambers for chemical and biological assays.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art may, using the preceding description and the following illustrative examples, make and utilize the devices of the present invention and practice the claimed methods. The following working examples therefore, specifically point out the preferred embodiments of the present invention, and are not to be construed as limiting in any way the remainder of the disclosure.

### Example 1

### Rapid Fabrication of PDMS Microstructures on Microscope Glass Slides Using Pop Slide Patterning Technique

The following example demonstrates a rapid, UV/plasma free method of fabricating microstructures on the surface of glass. This method produces polydimethylsiloxane (PDMS) features in the range of 10 μm on glass within 45 minutes. This rapid and easy method is cost effective and requires only a SU8 master mold and a standard hotplate while it is capable of being very easily reproduced in any lab setup.

The materials and methods are now described.

### Master Fabrication

Standard SU-8 photolithography technique was carried out on a 4 inch silicon wafer to produce master molds with patterns of interest. Feature heights in the silicon master were measured using a KLA-Tencor ASIQ profiler. Master molds produced from photoresists which are resistant against organic solvents such as hexane, isopropyl alcohol etc., are recommended to be used for the pop slide patterning method in order to avoid leaching of features in the master. Alternatively, silicon etched masters can also be used.

### Pop Slide Patterning

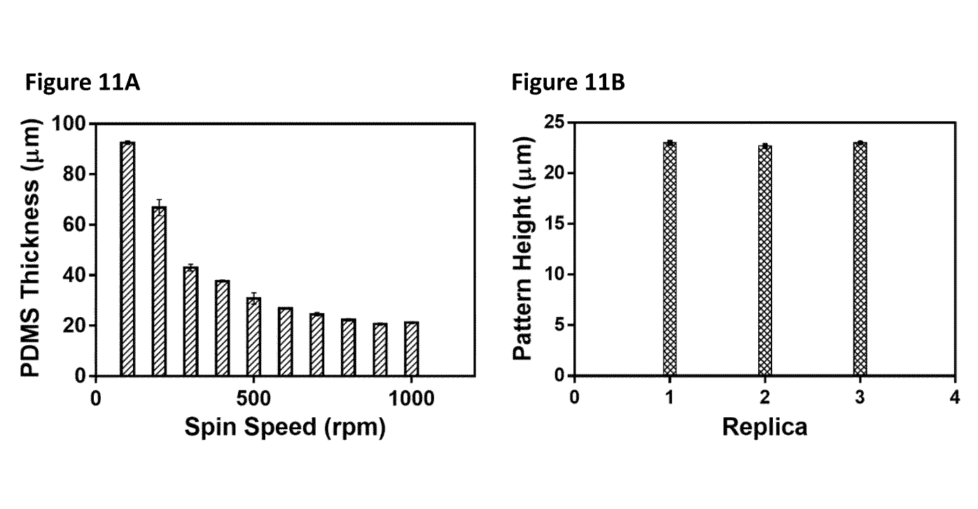

A schematic overview of the method is presented in FIG. 8. Briefly, 2 mL of a 1:1 mixture of PDMS (base+curing agent, 10:1) and a releasing agent (hexane) is poured to cover the surface of the feature or spin coated on the silicone master mold (FIG. 11A and FIG. 11B). Organic solvents which are soluble in PDMS and have a low boiling point are suitable releasing agents for this method.

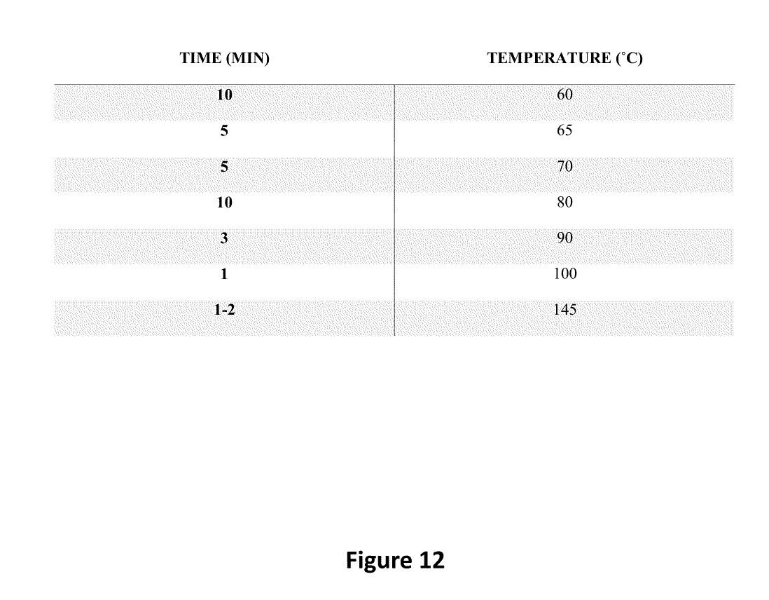

Compared to solvents such as isopropyl alcohol, hexane exhibited better release properties with negligible feature distortions. A glass slide is then placed carefully on top of the PDMS mixture covering the silicon master mold without introducing any air bubbles and is degassed (˜5-10 minutes) in a vacuum chamber to remove any air bubbles introduced in this step. Later, the master mold is baked on a hot plate through a series of temperatures (FIG. 12) to crosslink the PDMS. Excess PDMS on the sides of the glass slide is removed by using a scalpel once the PDMS has cured. This is an important step as it reduces the internal stress acting on the glass slide attached to the master mold. The master mold is then placed back on the hotplate and immediately heated to 145° C. This sudden heating causes the residual hexane to expand between the PDMS layer, thus assisting the glass slide to slightly pop out from the silicon master mold. The glass slide can then be lifted off from its edges using a scalpel. Excess PDMS sticking to the sides of the glass slide can be easily cut using a razor blade. The PDMS patterned glass slide is then rinsed with isopropyl alcohol and taped in order to remove any dust particles and is kept ready to be spotted with proteins of interest or used for cell culture.

### Imaging, Feature, and Step Height Analysis

In addition to observing the patterned features in bright field, a scanning electron microscope, SEM (Hitachi SU-70) was used to inspect the patterned features. The PDMS patterned glass slide was sputter coated (Denton chromium sputtering tool) with 20 nm of chromium prior to imaging. Feature height of the PDMS microstructures patterned on the glass slide were measured using a KLA-Tencor ASIQ profiler. Fluorescent images of protein (FITC-BSA) spotted in microwells and cells stained with live-cell stain (Calcein AM) cultured in microwells were obtained using a Nikon TiE fluorescent microscope and Evos FL Auto imaging system, respectively. All images were processed using ImageJ software.

### Protein Spotting and Cell Culture

A commercial microarray spotter, SpotBot 3 (Arrayit Inc., USA), was used to spot FITC-BSA inside the PDMS microwell array patterned on the glass slide. The latest version of the software SpotApp (v5.1.5) and Spocle Generator (v5.2.2) enabled the spotting proteins of interest in any region inside the glass slide.

HeLa cells were cultured in complete DMEM media on tissue culture dishes following standard cell culture protocols. Approximately 3 million cells/mL were seeded over a plasma treated glass slide containing the patterned PDMS microwells. A plain glass slide was placed on top of this to allow cells to attach specifically to sites inside the well and later removed and covered with complete media. The cells were allowed to grow overnight within the wells and imaged with a live/dead stain (Life Technologies, USA) after 24 hours upon cell seeding.

The results of the experiments are now described.

In contrast to other flexible transfer substrates like polyethylene sheets or PDMS layers, a microscope glass slide is more rigid and difficult to separate from the master mold once stuck to a PDMS layer. The addition of hexane (releasing agent) to the PDMS mixture—along with a series of heating steps—allows the PDMS to crosslink and lift off from the master mold while sticking to the glass slide as PDMS has more affinity for glass than for a silanized silicon master mold. Features as low as 10 μm or below (FIG. 2A through FIG. 2C) can be easily patterned on a glass slide using this technique.

This technique allows the replication of any features from the master mold with negligible distortion. Features such as wells and pillars of variable shapes and aspect ratios (height/width) can be easily fabricated using this method. For example, circular wells (FIG. 3A and FIG. 3B) and pillars (FIG. 3C and FIG. 3D) were achieved using this method. Triangular and squared wells and pillars with similar ranges of aspect ratios were also achieved (FIG. 4A through FIG. 4D, FIG. 5A through FIG. 5D).

When PDMS is poured over features with a higher aspect ratio, it gives rise to more bubbles, taking a longer time to degas. It is recommended to add an appropriate amount of the releasing agent in order to avoid excess loss of releasing agent during the degassing step. A 1:1 mixture of PDMS (base+curing agent, 10:1) and releasing agent is recommended while working with molds carrying features of higher aspect ratio. Sufficient baking time is necessary to allow the PDMS to crosslink prior to separating it from the master mold. Uncured PDMS or excess amounts of hexane might give rise to bubbles blemishing the PDMS patterns on the surface of glass. The baking time at different temperatures has been optimized for features with the aforementioned aspect ratios (FIG. 12).

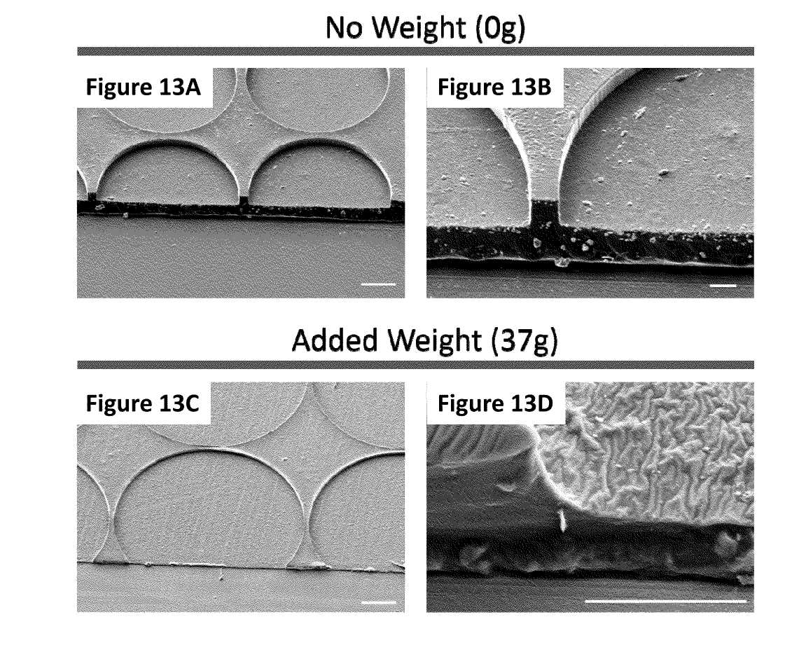

This technique produces a very thin layer of PDMS between PDMS microstructures and the surface of the glass slide, unlike through-glass bottom features produced by other surface micromachining methods. This layer is approximately 27-30 μm thick when the PDMS patterned slides are fabricated with no additional weight on top of the glass slide. Adding weights (in the form of aluminium blocks weighing around 37 g in total) on top of the glass slide during fabrication reduces the thickness of the PDMS layer between the glass slide and the patterned PDMS microstructures to 7-8 μm (FIG. 13A through FIG. 13D).

The pop slide patterning technique can be used for a variety of biological and analytical applications. Patterning a series of microwells on the surface of a glass slide facilitates high-content screening of biological analytes while simultaneously performing cell-based assays.

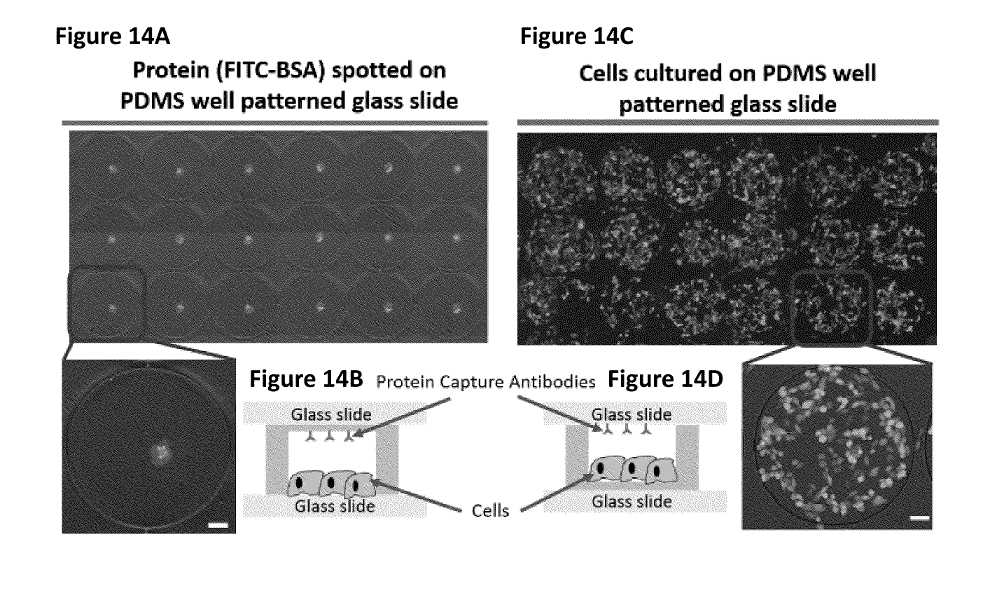

The PDMS microwell array patterned glass slides can be used in two different ways to study cell protein secretion profiles from a single/population of cells. In the first method (FIG. 14A and FIG. 14B), proteins/capture antibodies of interest can be spotted inside the microwell array and can later be sandwiched on top of cells/cell islands grown on a glass slide. This would serve as independent microchambers on which the secreted cytokines can be readily imaged using commercial microarray scanners. Live-cell staining with Calcein AM demonstrated that the patterned glass slides are biocompatible. This is also evidence that any residual hexane that did not evaporate during the heating step is not toxic to the cells.

The second method allows cells to be seeded inside the microwells while it is sandwiched by proteins/capture antibodies patterned on a glass slide (FIG. 14C and FIG. 14D). This forms a similar microcompartment to screen population level differences among the cells seeded in these microwells. Since the cells are attached to the bottom of the microwell, this method reduces the amount of stress that acts directly on these cells when compared to the above method. However, both methods would perform relatively well as similar approaches are currently practiced using thick PDMS casts.

In addition, patterning PDMS microstructures on glass would also serve as a promising platform to conduct bead-based microassays for quantification of proteins and other biomolecules such as DNA, RNA, lipids, and the like.

The pop slide patterning technique described herein is a novel approach to patterning PDMS microstructures onto the surface of a glass slide. The unique combination of a releasing agent and optimized heating temperatures enables the efficient production of open PDMS microstructures on glass in 35-45 minutes, which is 2-3 times faster than other methods. This simple method does not require expensive equipment, such as plasma cleaners, UV lamps, mask aligners, and reactive ion etchers; but rather can be performed in any lab with a standard hot plate. These PDMS patterned glass slides can readily be used for imaging applications due to the transparent nature of PDMS and the glass slide. Potential uses of this technique include, but are not limited to: high content quantitative imaging of cell- and bead-based assays in a microwell slide; production of microlens arrays on a glass slide; and easy fabrication of three-layer microfluidic devices with an added advantage to support imaging through the glass bottom.

### Example 2

### High Throughput Pop Slide Patterning

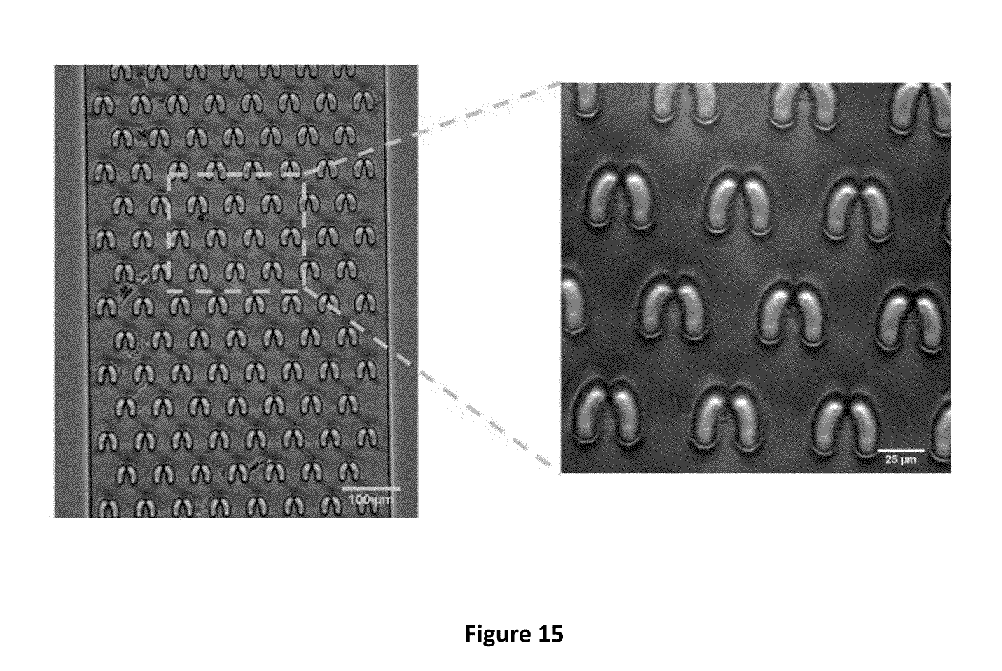

In order to increase the throughput of the patterned glass slides, the reverse of the pop slide patterning method was performed. The method is as follows: a plain glass slide was placed on a hot plate (covered with aluminium foil) at room temperature. The sides of the glass slide was sealed to the hot plate with a fire insulated adhesive tape so that it is easy to separate the glass slide from the PDMS stamp. A drop of PDMS (base:curing agent=10:1) and hexane solution (1:1=PDMS:hexane ratio), hereby referred to as PDMS solution, was placed on the glass slide and allowed to spread. The hotplate was set to 60° C., 65° C., and 70° C. for 1 minute and 30 seconds each. Following this, a silanized PDMS stamp with the desired reverse patterned microstructures was stamped onto the glass slide and remained in complete contact. The temperature was then increased to 80° C., 90° C., and 100° C. for 1 minute each with the stamp in full contact with the PDMS solution coated glass slide. The temperature was then increased to 145° C. following which the stamp was lifted from the glass slide. Upon removing the stamp, the glass slide was removed from the hotplate and finally allowed to cool for a few minutes. The microstructures patterned on the glass slide is represented in FIG. 15. These features were casted from a 7 μm U-shaped pillared microarray. The resulting microstructures produced on the glass slide are 7 μm U-shaped trenches.

Current hot embossing platforms, such as the JENOPTIK HEX machines, are very expensive and allow embossing features at the nanometer scale resolution. Other microtooling and micromachining approaches cannot achieve such a high resolution with microscale feature sizes. The present method can be adapted as an automated process, and in certain embodiments, can be capable of creating micropatterns on several glass slides (at least 20) within 10 minutes of operation (about 100 glass slides per hour).

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A method of fabricating devices having microstructures, comprising the steps of:
placing a preformed mold on a heat source;
covering the preformed mold with a polymer solution;
placing a substrate on the preformed mold and polymer solution;
heating the heat source to at least one temperature between 50 and 100° C. and holding for at least one period of time between 1 and 10 minutes;
heating the heat source to at least one temperature between 100 and 150° C. and holding for at least one period of time between 1 and 5 minutes; and
removing the substrate from the preformed mold;
wherein the substrate is removed with microstructures intact, having a thin polymer layer between the substrate and the microstructures.

2. The method of claim 1, further comprising a step of removing air pockets from the polymer solution by degassing after placing a substrate on the preformed mold and polymer solution.

3. The method of claim 1, further comprising a step of removing heat and trimming excess polymer from the substrate after heating the heat source to at least one temperature between 50 and 100° C. and holding for at least one period of time between 1 and 10 minutes.

4. A method of fabricating glass slides having PDMS microstructures, comprising the steps of:
placing a preformed mold on a heat source;
covering the preformed mold with a PDMS solution;
placing a glass slide on the preformed mold and PDMS solution;
removing air pockets from the PDMS solution by degassing;
heating the heat source to about 60° C. for 10 minutes, 65° C. for 5 minutes, 70° C. for 5 minutes, 80° C. for 10 minutes, 90° C. for 3 minutes, and 100° C. for 1 minute;
removing heat and trimming excess PDMS from the glass slide;
heating the heat source to about 145° C. for 1-2 minutes; and
removing the glass slide from the preformed mold;
wherein the glass slide is removed with microstructures intact, having a thin PDMS layer between the glass slide and the microstructures.

5. A high throughput method of fabricating devices having microstructures, the method comprising the steps of:
placing a substrate on a heat source;
covering the substrate surface with a polymer solution;
heating the heat source to at least one temperature between 50 and 75° C. and holding for at least one period of time between 1 and 5 minutes;
placing a preformed mold on the substrate and polymer solution;
heating the heat source to at least one temperature between 75 and 150° C. and holding for at least one period of time between 1 and 5 minutes; and
removing the preformed mold from the substrate;
wherein the substrate retains intact microstructures, having a thin polymer layer between the substrate and the microstructures.

6. A high throughput method of fabricating glass slides having PDMS microstructures, the method comprising the steps of:
placing a glass slide on a heat source;
covering the glass slide surface with a PDMS solution;
heating the heat source to about 60° C., 65° C., and 70° C. for 1.5 minutes at each temperature;
placing a preformed mold on the glass slide and PDMS solution;
heating the heat source to about 80° C., 90° C., 100° C., and 145° C. for 1 minute at each temperature; and
removing the preformed mold from the glass slide;
wherein the glass slide retains intact microstructures, having a thin PDMS layer between the glass slide and the microstructures.

7. The method of claim 1, wherein the polymer solution comprises a thermosetting polymer and an organic solvent.

8. The method of claim 4, wherein the PDMS solution comprises a 1:1 mixture of hexane and PDMS mixture.

9. The method of claim 8, wherein the PDMS mixture comprises a 1:10 mixture of curing agent and PDMS base.

10. The method of claim 1, wherein the preformed mold comprises a photoresist.

11. The method of claim 10, wherein the preformed mold comprises SU-8.

12. The method of claim 1, wherein the preformed mold is resistant to organic solvents.

13. The method of claim 1, wherein the preformed mold is resistant to temperatures of at least 200° C.

14. The method of claim 1, wherein the substrate comprises a planar surface.

15. The method of claim 1, wherein the substrate comprises a glass slide.

16. The method of claim 1, wherein the substrate is resistant to temperatures of at least 200° C.

17. The method of claim 1, wherein a weight is placed on the substrate or mold to decrease the thickness of the thin polymer or PDMS layer.

18. The method of claim 1, wherein the intact microstructures are selected from the group consisting of: micropillars, microwells, microchannels, and microlenses.

19. The method of claim 1, further comprising a step of covering at least a portion of the intact microstructures with a second substrate surface.

20. The device fabricated by the method of claim 1.
